(19) United States
(12) Patent Application Publication
(10) Pub. No.: US 2024/0029175 A1
(43) Pub. Date: Jan. 25, 2024

(54) INTELLIGENT DOCUMENT PROCESSING

(71) Applicant: INTUIT INC., Mountain View, CA (US)

(72) Inventors: Vignesh SUBRAHMANIAM, Bangalore (IN); Sadaf Riyaz SAYYAD, Bangalore (IN); Punam GOSWAMI, Bangalore (IN); Arun SINGH, Bangalore (IN); Chenbaga M K, Bangalore (IN); Joseph JOICE, Bangalore (IN); Sumit Kumar PODDAR, Bangalore (IN); Anandagouda PATIL, Bangalore (IN); Natarajan SWAMINATHAN, Bangalore (IN); Arkadeep BANERJEE, Bangalore (IN)

(73) Assignee: INTUIT INC., Mountain View, CA (US)

(21) Appl. No.: 17/814,760

(22) Filed: Jul. 25, 2022

(51) Int. Cl. G06Q 40/00; G06N 5/04

(52) U.S. Cl. CPC G06Q 40/123; G06N 5/04

(57) ABSTRACT

Systems and methods that process, classify, and provide intelligent insights related to received documents such as notice documents in real-time. The system and methods leverage a novel framework of artificial intelligence and machine learning techniques to identify a requirement in the document (e.g., a government notice) and generate actionable suggestions thereto.

### BACKGROUND

People receive many notice type documents requiring them to respond to the notice by a certain date. For example, a tax notice is a letter from a state or national tax agency that alerts a taxpayer about an issue with his or her account, tax return, or tax payment schedule. Tax agencies issue tax notices printed on paper, noting the reason that the notice was issued, the amount of the tax that may be owed, and in some instances a due date to address the notice by. Such notices need physical intervention to read, understand, and analyze the cause of the notice as tax notices are complex.

There are thousands of different types of documents that a person may receive, particularly with respect to notice documents. For example, there are approximately over 1500 different types of Internal Revenue Service (IRS) tax notices, which depending on the cause of the notice, the content and resolution action differs among them. Given the manual process by which notice documents are currently resolved, there is a need for an intelligent solution that can understand or recognize a document such as a notice document and provide some upfront information that can help resolve the noticed issue.

### SUMMARY

The instant system and methods provide novel techniques for overcoming the deficiencies of conventional systems by replacing manual processes of reviewing documents such as notice documents and data entry of noticed information with novel automated artificial intelligence and machine learning techniques for recognizing, identifying, categorizing, and extracting relevant information from the document. In addition, one or more artificial intelligence and machine learning models used by the system and method are refined throughout the process to improve computing resource efficiency.

### BRIEF DESCRIPTION OF THE FIGURES

FIG. 1 illustrates a computing environment, according to various embodiments of the present disclosure.

FIG. 2 illustrates a notice document processing framework, according to various embodiments of the present disclosure.

FIG. 3 illustrates a method for processing a notice document, according to various embodiments of the present disclosure.

FIG. 4 illustrates an interactive graphical user interface, according to various embodiments of the present disclosure.

FIG. 5 illustrates a block diagram for a computing device, according to various embodiments of the present disclosure.

### DETAILED DESCRIPTION OF SEVERAL EMBODIMENTS

Embodiments of the present disclosure relate to systems and methods for intelligent document (e.g., notice documents) processing, artificial intelligence/machine learning classification related to the document, and refining of the machine learning model(s) used in the process. The implementation of these novel concepts may include, in one respect, implementation of one or more artificial intelligence techniques and one or more machine learning models that, in response to receiving a document such as a notice document, identify the document using computer vision techniques, extract relevant information from the document using natural language processing, and provide intelligent suggestions or immediate solutions to the user.

The disclosed principles are described with reference to a tax notice document and processing performed by an electronic tax, accounting and or financial service, but it should be understood that these principles may apply to any type of document requiring processing and or a response by a recipient of the document and any electronic service or system that processes or uses said documents. Accordingly, the disclosed principles are not limited to use with tax documents or notice documents.

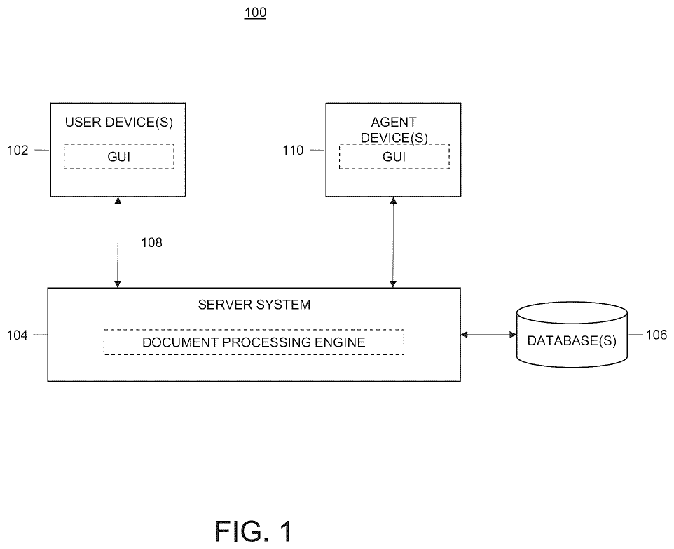

Referring to FIG. 1, computing environment 100 can be configured to automatically and intelligently process documents such as notice documents issued by a government agency, or other entity (e.g., automotive manufacturer), according to embodiments of the present disclosure. Computing environment 100 may include one or more user device(s) 102, a server system 104, one or more databases 106, one or more agent device(s) 110, communicatively coupled to the server system 104. The user device(s) 102, one or more agent device(s) 110, server system 104, and database(s) 106 may be configured to communicate through network 108.

In one or more embodiments, user device(s) 102 is operated by a user. User device(s) 102 may be representative of a mobile device, a tablet, a desktop computer, or any computing system having the capabilities described herein. Users may include, but are not limited to, individuals such as, for example, individuals, companies, prospective clients, and or customers of an entity associated with server system 104, such as individuals who have received a notice document and are utilizing the services of, or consultation from, an entity associated with that document and server system 104.

User device(s) 102 according to the present disclosure may include, without limit, any combination of mobile phones, smart phones, tablet computers, laptop computers, desktop computers, server computers or any other computing device configured to capture, receive, store and/or disseminate any suitable data. In one embodiment, a user device(s) 102 includes a non-transitory memory, one or more processors including machine readable instructions, a communications interface which may be used to communicate with the server system (and, in some examples, with the database(s) 106), a user input interface for inputting data and/or information to the user device and/or a user display interface for presenting data and/or information on the user device. In some embodiments, the user input interface and the user display interface are configured as an interactive graphical user interface (GUI). The user device(s) 102 are also configured to provide the server system 104, via the interactive GUI, input information (e.g., documents such as e.g., tax notices and information associated therewith) for further processing. In some embodiments, the interactive GUI is hosted by the server system 104 or provided via a client application operating on the user device. In some embodiments, a user operating the user device(s) 102 may query server system 104 for information related to a received document (e.g., a tax notice).

Server system 104 hosts, stores, and operates a document processing engine, or the like, for automatically identifying and intelligent processing of documents associated with the underlying service supported by the system 104. For example, if the server system 104 supports or provides a tax service, it will include the capability to process tax documents such as tax notices.

The document processing engine may asynchronously monitor and enable the submission of documents (e.g., tax notices) received by the user device(s) 102. The server system 104, in response to receiving the one or more documents, converts the document to a computer interpretable format via one or more computer vision techniques and extract text from the document. In one or more embodiments, the server system 104 removes predetermined objects from the document and maps the remaining text to one or more vectors using natural language processing such as, for example, via a term frequency inverse document frequency model, countvectorizer, and one-hot encoder. The server system 104 identifies a document type associated with the document included in the extracted text. Here, identifying a document type associated with the document included in the extracted text further comprises comparing the type of document with a list of known document types. The server system 104 classifies the document using a machine learning classification model based on the document type and historical training data. For example, the machine learning classification model includes a tree-based ensemble model, wherein each tree-based model within the tree-based ensemble model is trained on a different feature associated with one or more previously analyzed documents. The tree-based ensemble model outputs a score that indicates a probability of the document being associated with a pre-defined category. In one or more embodiments, the server system 104 retrains the natural language processing model and machine learning classification model using the classification of the document and downstream actions taken with the document. The server system 104 further generates instructions for displaying the type of document and user actions that can be taken with the type of document via a graphical user interface with an incorporated intelligent chat tool. The aforementioned techniques provide accurate classification and automated solutions that improve upon prior methods for identifying documents (e.g., tax notices) that require manual document identification and data entry of document information by a human.

The server system 104 may be further configured to implement two-factor authentication, Secure Sockets Layer (SSL) protocols for encrypted communication sessions, biometric authentication, and token-based authentication. The server system 104 may include one or more processors, servers, databases, communication/traffic routers, non-transitory memory, modules, and interface components.

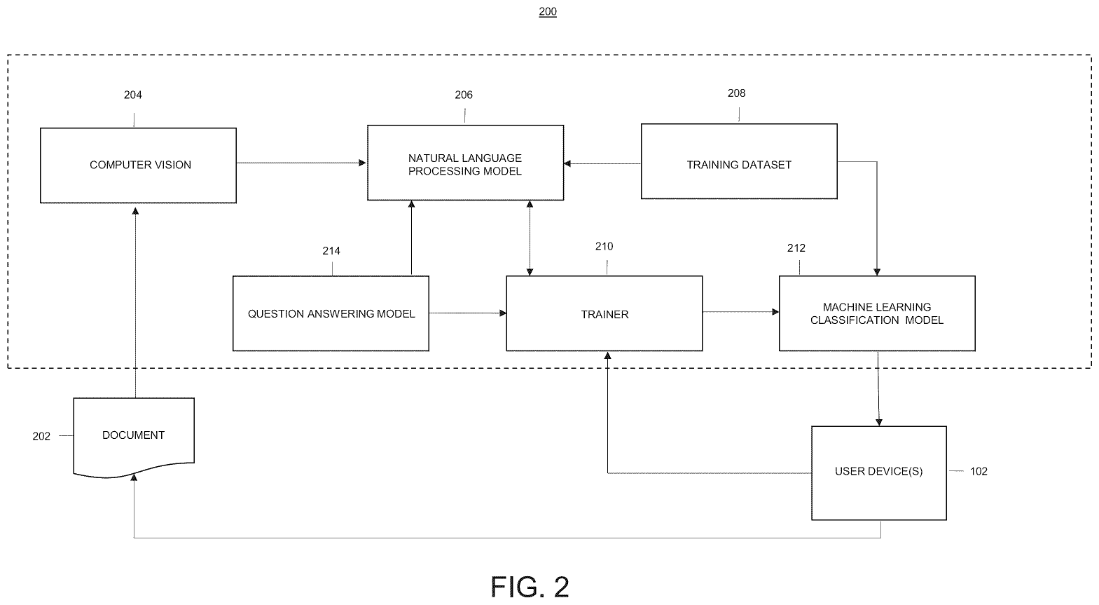

Database(s) 106 may be locally managed and/or a cloud-based collection of organized data stored across one or more storage devices and may be complex and developed using one or more design schema and modeling techniques. In one or more embodiments, the database system may be hosted at one or more data centers operated by a cloud computing service provider. The database(s) 106 may be geographically proximal to or remote from the server system 104 configured for data dictionary management, data storage management, multi-user access control, data integrity, backup and recovery management, database access language application programming interface (API) management, and the like. The database(s) 106 are in communication with the server system 104 and the user device(s) 102 via network 108. The database(s) 106 store various data, including one or more tables, that can be modified via queries initiated by users operating user device(s) 102. In one or more embodiments, various data in the database(s) 106 will be refined over time using a natural language processing model, for example the natural language processing model discussed below with respect to FIGS. 2, 3, and 5. In one or more embodiments, database(s) 106 additionally stores training data and historical training data used to train and refine the natural language processing model and/or a machine learning model. Additionally, the database system may be deployed and maintained automatically by one or more components shown in FIG. 1.

Network 108 is any suitable network, including individual connections via the Internet, such as cellular or Wi-Fi networks. In some embodiments, network 108 connects terminals, services, and mobile devices using direct connections, such as radio frequency identification (RFID), near-field communication (NFC), Bluetooth™, low-energy Bluetooth™ (BLE), Wi-Fi™, ZigBee™, ambient backscatter communication (ABC) protocols, USB, WAN, LAN, or the Internet. Because the information transmitted may be personal or confidential, security concerns may dictate one or more of these types of connection be encrypted or otherwise secured. In some embodiments, however, the information being transmitted may be less personal, and therefore, the network connections may be selected for convenience over security.

For example, network 108 may be the Internet, a private data network, virtual private network using a public network and/or other suitable connection(s) that enables components in computing environment 100 to send and receive information between the components of computing environment 100.

In one or more embodiments, each agent device(s) 110 is operated by a user under the supervision of the entity hosting and/or managing server system 104. Agent device(s) 110 may be representative of a mobile device, a tablet, a desktop computer, or any computing system having the capabilities described herein. Users of the agent device(s) 110 include, but are not limited to, individuals such as, for example, software engineers, database administrators, employees, and/or customer service agents, of an entity associated with server system 104.

Agent device(s) 110 according to the present disclosure include, without limitation, any combination of mobile phones, smart phones, tablet computers, laptop computers, desktop computers, server computers or any other computing device configured to capture, receive, store and/or disseminate any suitable data. In one embodiment, each agent device(s) 110 includes a non-transitory memory, one or more processors including machine readable instructions, a communications interface that may be used to communicate with the server system (and, in some examples, with the database(s) 106), a user input interface for inputting data and/or information to the user device and/or a user display interface for presenting data and/or information on the user device. In some examples, the user input interface and the user display interface are configured as an interactive GUI. The agent device(s) 110 are also configured to provide the server system 104, via the interactive GUI, input information (e.g., queries, questions, prompts, and code) for further processing. In some examples, the interactive GUI is be hosted by the server system 104 or it can be provided via a client application operating on the user device.

Referring to FIG. 2, a document processing framework 200 is depicted, according to various embodiments of the present disclosure. Framework 200 provides components and processes for evaluating a document using natural language processing, performing domain specific feature engineering of document data, and classifying the document using machine learning and further based on the domain specific feature engineering of document data. These features provide an improvement of the prior art which required manual human interpretation and classification of documents issued by tax issuing agencies. As shown, the framework includes a computer vision component 204 configured and capable of receiving a scanned image of a document 202 (e.g., a tax notice in an image or PDF format) from a user device(s) 102 and converting this image to text. In one embodiment, the image to text extraction process implemented by the computer vision component 204 converts the document from a PDF format to a JPEG file readable by optical character recognition (OCR) engine. Computer vision component 204 may be further configured to save the text read from the OCR engine as a single text file.

As shown, document processing framework 200 includes a natural language processing model component 206. Natural language processing model component 206 is configured and capable of receiving the text file and pre-processing the text in the text file to clean, remove, and/or extract predetermined objects, such as punctuation, extra white spaces, and the like. In one or more embodiments, natural language processing model component 206 is further configured to convert text into uppercase/lowercase text and tokenize the text. In one or more embodiments, natural language processing model component 206 is additionally configured to implement term frequency inverse document frequency (TF-IDF) word embedding on the pre-processed text, wherein the pre-processed text is converted to a numerical format (e.g., a vector). Notably, Natural language processing model component 206 may also implement a countvectorizer to tokenize text and one-hot encoding to transform categorical data into numerical format. In addition, or alternatively, one or more additional language models (e.g., Word2Vec, GloVe, BERT etc.) may be utilized to convert words to a numerical value.

Training dataset 208 is a corpus of historical training data comprised of numerous documents (e.g., tax notices) previously run through the natural language processing model component 206. The training dataset 208 is utilized to refine and pretrain the natural language processing model component 206. The training dataset 208 may additionally include information pertaining to whether a document was issued by, for example, a federal or state agency, is of a certain type (e.g., manage tax notice or manage tax data), and or sub-type (e.g., With-holding (WH), Unemployment insurance (UI) or one or more other tax notice types). The training dataset 208 may additionally include historical actions taken by one or more tax professionals as it relates to previous document (e.g., tax notices received by the system). Training dataset 208 can additionally be used to train and refine machine learning classification model component 212.

Trainer 210 fine tunes the natural language processing model using the training dataset 208, producing a natural language processing model that is continuously refined as more documents are added to the training dataset 208. In addition, in one or more embodiments, trainer 210 is configured to refine machine learning classification model component 212 based on the accuracy of the model's predictions and feedback from user device(s) 102.

In one or more embodiments, machine learning classification model component 212 is configured and/or capable of classifying the document using a tree-based ensemble model. In one or more embodiments, machine learning classification model component 212 is a supervised model.

As shown, document processing framework 200 includes a question answering model component 214. In one or more embodiments question answering model component 214 is a phrase-index question answering model configured for interpreting text within a document (e.g., a tax notice), understanding questions asked in natural language regarding the document, and producing word embeddings and confidence scores that can be used as input for one or more downstream tasks (e.g., to the natural language processing model component 206 and/or the trainer 210).

Notably, the question answering model component 214 is configured to receive both documents and question phrases as inputs and leverages a separate encoder for both the document and the question phrases. In this instance, all documents are processed independently of the question phrase, and the question answering model component 214 generates an index vector for each candidate answer within the document.

Separately, at inference time, an index vector is generated for the question phrase, which is mapped to the same vector space as the index vector for each candidate answer, and the candidate answer with the nearest index vector to the question phrase index phrase is obtained. In one or more non-limiting embodiments, the question phrases presented to the question answering model component 214 include a list of predetermined questions. For example, a first question could be what field office does the tax notice originate from? A second question could be, what is the penalty reflected on the tax notice? A third question could be, what are dates reflected on the tax notice (e.g., what date was the notice issued, and what the tax notice response due date)?

As discussed above, the candidate answers to these questions (i.e., the candidate answers with the nearest index vector to the question phrase index vector) is obtained in the form of embeddings, and leveraged as output along with a confidence score, both of which are used as input for one or more downstream tasks. For example, as input for the natural language processing model component 206 and/or training by trainer 210.

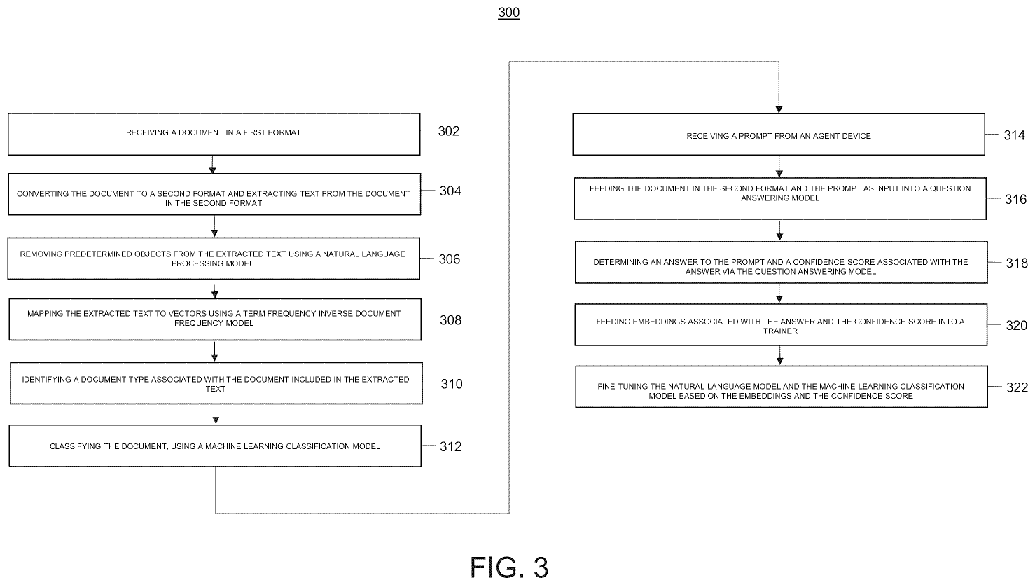

Referring to FIG. 3, a method for processing a document 300 is depicted, according to various embodiments of the present disclosure. At step 302, server system 104 receives a document (e.g., a tax notice) in a first format (e.g., PDF format) from a user device. For example, server system 104 may receive a tax notice from a user (e.g., an individual that has been issued a tax notice) operating the one or more user device(s) 102 requesting additional information about the tax notice from an entity associated with operating server system 104.

At step 304, server system 104 converts the document to a second format (e.g., JPEG) and extract text from the document in the second format. For example, server system 104 implements one or more computer vision techniques (via computer vision component 204) to convert the document, which may be in a PDF format, to an image stored in a JPEG format. Server system 104 further extracts text from the image using OCR and saves the extracted text in a text file.

At step 306, server system 104 may remove one or more predetermined objects from the extracted text in the text file using a natural language processing model (via natural language processing model component 206). For example, server system 104 compares the text in the text file to a list of predetermined objects that need to be extracted, cleaned, and/or removed, from the text file. In one or more embodiments, the list of predetermined objects includes white spaces, and or punctuation. In one or more embodiments, server system 104 converts text to uppercase/lowercase text and tokenizes the text via a countvectorizer, which transforms a given text into a vector on the basis of the frequency (count) of each word that occurs in the entire text. The countvectorizer may create a matrix in which, for example, each unique word is represented by a column of the matrix, and each text sample from the document is a row in the matrix. In addition, or alternatively, server system 104 user one-hot encoding to transform any categorical data into numerical form.

At step 308, server system 104 maps the extracted text to vectors using natural language processing model component 206, which in the illustrated example includes a term frequency inverse document frequency (TF-IDF) model. Here, the server system may take the output of the text, countvectorizer and/or one-hot encoding as input. Server system 104 may have previously trained the TF-IDF model on all documents (e.g., one or more tax notices) previously submitted by users and/or included in training dataset 208. The natural language processing model component 206 outputs the relative importance of each word in the text file (previously extracted from the document) in comparison to the rest of the corpus. The number of times a term occurs in the text file is known as the term frequency. Inverse document frequency diminishes the weight of terms that occur frequently in the text file set but increases the weight of terms that occur rarely. For example, a TF-IDF score increases proportionally to the number of times a word appears in the text file and is offset by the number of documents in the corpus that contain the word, which may adjust for the fact that some words appear more frequently in general.

In one non-limiting example, the TF-IDF score is calculated as follows:

TF×IDF

wherein TF(t)=(number of times term (or word) ‘t’ appears in a document) divided by the (total number of terms (or words) in the document); and IDF(t)=log (total number of documents) divided by the (number of documents with term (or word) ‘t’ in it).

The TF-IDF score provides an indication of how important each word is across the corpus. Here, the higher the TF-IDF score, the more significant and/or important the word is.

In one embodiment, the TF-IDF model computes a score for each word in the text file, thus approximating each word's importance. Then, each individual word score is used to compute a composite score for the text file by summing the individual scores of each word.

In another embodiment, instead of utilizing a TF-IDF model as natural language processing model component 206, server system 104 alternatively implements a Word2Vec, GloVe, or bidirectional encoder representation from transformers (BERT) model. In implementing the Word2Vec model, server system 104 leverages a two-layer neural network that is trained to reconstruct linguistic contexts of words. The Word2Vec model uses the training dataset 208 as input and produces a vector space, typically of several hundred dimensions, with each unique word in the corpus being assigned a corresponding vector in the space. There are two types of Word2vec that may be used with the disclosed principles: the continuous bag-of-words model (CBOW) and the skip-gram model. Algorithmically, these models are similar, except that CBOW predicts target words (e.g., “mat”) from source context words (“the cat sits on the”), while the skip-gram model does the inverse and predicts source context-words from the target words.

Alternatively, the natural language processing model component 206 may use a GloVe model, which uses neural methods to decompose a co-occurrence matrix into more expressive and dense word vectors. Specifically, GloVe is an unsupervised learning algorithm for obtaining vector representations for words. Training is performed on aggregated global word-word co-occurrence statistics from training dataset 208, and the resulting representations showcase unique linear substructures of the word vector space.

In another instance, server system 104 may leverage a BERT model within the natural language processing model component 206. A BERT model includes various transformer encoder blocks that are trained to understand contextual relations between words. A BERT model can analyze text bidirectionally instead of left to right or right to left. A standard BERT model can include two mechanisms in its transformer: an encoder that can read input text and a decoder that predicts text to follow the input text. A BERT model may operate on and process word or text vectors (e.g., text that has been embedded to a vector space). A neural network with layers (e.g., various transformer blocks, self-attention heads) then analyzes the word vectors for prediction or classification.

At step 310, server system 104 identifies a document type associated with the document included in the extracted text (or document) . Here, server system 104 may parse the extracted text to search for a document type identifier known be associated with the document (e.g., tax notice). For example, server system 104 may parse the extracted text for numbers (or another document type identifier) compare any identified number(s) form the extracted text to a list of numbers known to be associated with and included on a tax notice, and produce the identified number(s) as output for use by subsequent processes. In some instances, the identified numbers in the extracted text may be form numbers used to identify the document. For example, a withholding type of tax notice has a greater probability of having the terms “Form 941” and Unemployment insurance “Form 940”. In addition, database(s) 106 may store a list of known document numbers (or identifiers). Server system 104 may parse the extracted text (or document) for the document type (or document type identifier) (e.g., “941”) and compare it to the list of known document numbers stored in the database(s) 106. Server system 104 may determine if there is a match between the document type found in the extracted text (e.g., “941”) and the document number on the list. Server system 104 may leverage the match as an output for one or more downstream processes (e.g., classification of the document).

At step 312, server system 104 classifies the document using machine learning classification model (via machine learning classification model component 212). In one embodiment, the machine learning classification model is a supervised model. Server system 104 may have pre-trained the machine learning classification model on the training dataset 208 comprising historical data, labels, categorizations of documents (e.g., whether the document was issued by a federal or state/local agency, is a manage tax notice or includes manage tax data, and or is of a sub-type, including but not limited to withholding (WH), unemployment insurance (UI) or one or more other tax notice types), and actions previously taken by professionals associated with the document as it relates to the previously analyzed documents. Notably, these classifications can be used as labels for training the machine learning classification model. As such, machine learning classification model passes the training dataset 208, pre-processed text produced at 306, the output of the utilized natural language processing model (TF-IDF) at step 308, as an input to a tree-based ensemble to classify the document type. In furtherance of classifying the document, the tree-based ensemble may leverage decision trees, wherein the decision tree makes a classification by dividing inputs into smaller classifications (at nodes), which result in an ultimate classification at a leaf.

In one or more embodiments, the machine learning classification model may additionally leverage one or more other models, such as gradient boosting, which is a method for optimizing decision-tree based models. Gradient boosting generally involves building an ensemble of prediction models such as decision trees. The ensemble of prediction models making up the gradient boosted tree model may be built in a stage-wise fashion (e.g., iteratively improved through a series of stages), and the prediction models may be generalized to allow optimization of an arbitrary differentiable loss function. For example, each decision tree of a gradient boosted tree model may be trained based on associations between input features corresponding to previously processed tax notices in the training dataset 208 and labels categorizing the tax notices.

In some embodiments, for a specific example involving a tax document, the training a tree-based model ensemble model comprises training a first tree-based model of the plurality of tree-based models, on a specific feature, for example, an action taken by a tax professional (or a user associated with the tax professional) as it relates to one or more previously analyzed/classified tax notices included in training dataset 208. A second tree-based model of the plurality of tree-based models may also be trained based on given yet different features (than that of the first tree-based model) relating to embeddings, text, or identifiers, associated with or identified in one or more previously analyzed/classified tax notices included in training dataset 208. A third tree-based model of the plurality of tree-based models may also be trained based on certain (than that of the first and second tree-based models) features related to the source (e.g., federal tax agency or state tax agency) and/or the type or subtype of notice of the one or more previously analyzed/classified tax notices were determined to be. Notably, the output of the tree-based models is a score which correlates with probability (i.e., likelihood) of the document being of a pre-defined category.

Accordingly, in some embodiments, the output of the machine learning classification model, that is, the tax notice's classification into a predefined category or tax notice type, may be leveraged by downstream processes for various purposes. For example, the output of the machine learning model may be leveraged by server system 104 to provide a user operating user device(s) 102 with tax notice related information. In addition, the output of the machine learning model may be leveraged by the server system 104 to further refine and train the natural language processing model and the machine learning classification model. In one instance, in response to determining the document's category, the server system 104 extracts relevant information from the extracted text.

At 314 server system 104 receives a prompt (e.g., a question) from one or more agent device(s) 110. For example, an agent (e.g., a software engineer) operating agent device(s) 110 will submit a question (in real-time or after the document has been classified) or query to server system 104 relating to details recited on a tax notice.

At 316 server system 104 is configured to feed the document in the second format and the prompt to the question answering model component 214. For example, server system 104 will use the document in the second format and the user's question as input for a phrase indexed question answering model that is capable of interpreting the agent's natural language question; and identifying and providing an answer.

At 318 server system 104 is configured to determine an answer to the prompt via the question and answering model component 214. Server system 104 is further configured to leverage one or more information retrieval modules that identify candidate answers within the document that may contain the answer to the agent's question. In furtherance of identifying an answer, server system 104 is configured to evaluate an index vector associated with document and compare it to an index vector associated with the agent's question. Each identified candidate answer will be evaluated, and the candidate answer with the nearest index vector to the question index vector is obtained. Notably, the question answering model component 214 is also configured to determine a confidence score for the identified candidate answer. In addition, the ability of the server system 104 to identify an answer or lack thereof adds an explainability layer to the question answering model component 214 in that the more answers that are able to be identified in view of the questions asked, the more likely the document is e.g., a tax notice; and a tax notice of a particular type that was classified by the machine learning classification model component 212. However, the inability of server system 104 to identify answers in response to the questions suggests that the document that is being analyzed is not a tax notice and/or not the type of tax notice that machine learning classification model component 212 identified it as.

At 320 server system 104 is configured to feed word embeddings associated with the identified candidate answer and the confidence score to one or more downstream tasks (e.g., the natural language processing model component 206 or to the trainer 210). In one non-limiting embodiment, the word embeddings and confidence score are fed into the trainer 210. In another non-limiting embodiment, the word embeddings and confidence score are fed to the natural language processing model component 206.

At 322 server system 104 is configured to fine tune the natural language processing model component 206 and/or the machine learning classification model component 212 based on the word embeddings and the confidence score. For example, the natural language processing model component 206 and trainer 210 may receive the word embeddings and confidence score. Server system 104 is configured to refine and/or adjust various hyperparameters of the natural language processing model component 206 and the machine learning classification model component 212 (via the trainer 210) based on the word embeddings and confidence score.

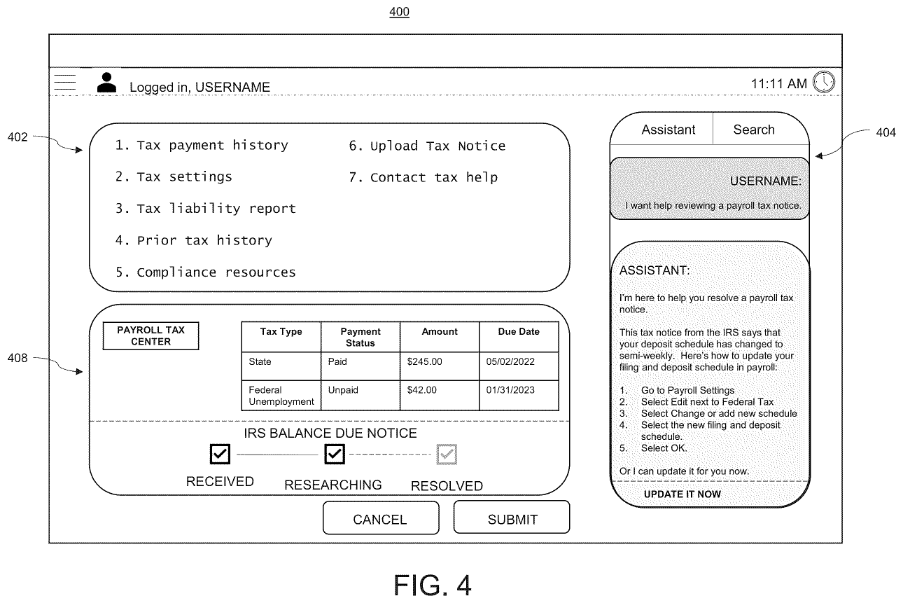

FIG. 4 illustrates an interactive graphical user interface (GUI) 400 depicted, according to various embodiments of the present disclosure. In some instances, the interactive GUI 400 may be a stand-alone application, or a sub-feature associated within a software product or website. The interactive GUI 400 may be operated by one or more users using one or more user device(s) 102. In some embodiments, interactive GUI 400 initiates and plays an integral role for processes associated with training a natural language processing model (implemented by natural language processing model component 206) or a machine learning classification model (implemented by machine learning classification model component 212) referenced in and/or a method for providing suggestions or additional information to a user as briefly discussed with respect to FIGS. 2-3. As depicted in FIG. 4, interactive GUI 400 includes several dynamic features for capturing documents (a tax notice in this example), receiving settings/preference information, and providing tax-related suggestions and information in real-time. In the illustrated example, interactive GUI 400 includes a user tax profile region 402, automated intelligent assistant and search region 404, and dynamic results region 408.

As depicted in user tax profile region 402, a series of user profile-related options may be populated in response to the type of action being performed by a user and/or in response to real-time updates occurring in the automated intelligent assistant and search region 404, and/or the dynamic results region 408. For example, a user may leverage user tax profile region 402 to upload and provide a tax notice to server system 104 to receive additional information about the tax notice. In addition, or alternatively, tax profile region 402 may be populated with certain options based on a dialogue that occurs between the user and an automated intelligent assistant occurring in automated intelligent assistant and search region 404 or in response to a document (e.g., a tax notice) that was uploaded to the server system 104.

Automated intelligent assistant and search region 404 may enable a user to receive additional information or suggestions regarding a particular document (e.g., a tax notice) or a specific topic (e.g., unemployment tax) in real-time via an automated intelligent assistant or intelligent search tool. For example, in response to uploading a tax notice, the automated intelligent assistant initiates communication with a user via a chat box within the region and provides information related to the tax notice, such as the type of tax notice that the user uploaded and suggestions where data gleaned from the tax notice may need to be input into the user's tax profile. As another example, a user may conduct a search in the automated intelligent assistant and search region 404 to find additional resources and information. In addition, the automated intelligent assistant and search region 404 automatically updates the user's tax profile and tax records with the various information gleaned from the tax notice.

Dynamic results region 408 may dynamically populate with relevant editable information and tools, in response to the type of activity the user is engaged in. For example, in response to the user uploading a tax notice, dynamic results region 408 automatically populates with information related to or contained in the tax notice (e.g., the cause of the tax notice and/or tax period). In addition, or alternatively, dynamic results region 408 populates the information related to or contained in the tax notice in response to a user request. Dynamic results region 408 enables and/or prompts a user to add the information displayed therein to the user's tax profile or to a specific field. Dynamic results region 408 additionally allows a user to modify certain tax schedules and/or see the status of previous tax-related actions.

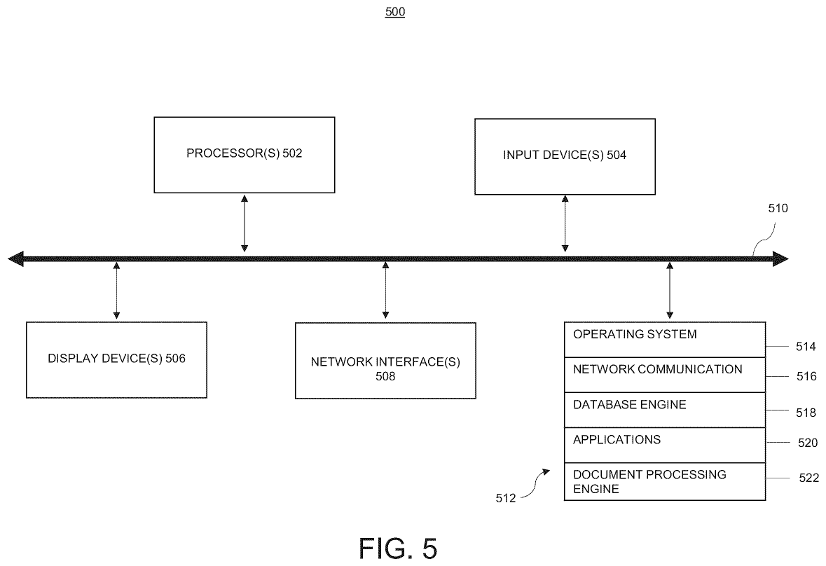

FIG. 5 illustrates a block diagram for a computing device, according to various embodiments of the present disclosure. For example, computing device 500 may function as server system 104. The computing device 500 may be implemented on any electronic device that runs software applications derived from compiled instructions, including without limitation personal computers, servers, smart phones, media players, electronic tablets, game consoles, email devices, etc. In some implementations, the computing device 500 may include processor(s) 502, (one or more) input device(s) 504, one or more display device(s) 506, one or more network interfaces 508, and one or more computer-readable medium(s) 512 storing software instructions. Each of these components may be coupled by bus 510, and in some embodiments, these components may be distributed among multiple physical locations and coupled by a network 108.

Display device(s) 506 may be any known display technology, including but not limited to display devices using Liquid Crystal Display (LCD) or Light Emitting Diode (LED) technology. Processor(s) 502 may use any known processor technology, including but not limited to graphics processors and multi-core processors. Input device(s) 504 may be any known input device technology, including but not limited to a keyboard (including a virtual keyboard), mouse, track ball, camera, and touch-sensitive pad or display. Bus 510 may be any known internal or external bus technology, including but not limited to ISA, EISA, PCI, PCI Express, USB, Serial ATA or FireWire. Computer-readable medium(s) 512 may be any non-transitory medium that participates in providing instructions to processor(s) 502 for execution, including without limitation, non-volatile storage media (e.g., optical disks, magnetic disks, flash drives, etc.), or volatile media (e.g., SDRAM, ROM, etc.).

Computer-readable medium(s) 512 may include various instructions for implementing an operating system 514 (e.g., Mac OS®, Windows®, Linux). The operating system may be multi-user, multiprocessing, multitasking, multithreading, real-time, and the like. The operating system may perform basic tasks, including but not limited to: recognizing input from input device(s) 504; sending output to display device(s) 506; keeping track of files and directories on computer-readable medium(s) 512; controlling peripheral devices (e.g., disk drives, printers, etc.) which can be controlled directly or through an I/O controller; and managing traffic on bus 510. Network communications instructions 516 may establish and maintain network connections (e.g., software for implementing communication protocols, such as TCP/IP, HTTP, Ethernet, telephony, etc.).

Database processing engine 518 may include instructions that enable computing device 500 to implement one or more methods as described herein. Application(s) 520 may be an application that uses or implements the processes described herein and/or other processes. The processes may also be implemented in operating system 514. For example, application(s) 520 and/or operating system 514 may execute one or more operations to intelligently process documents (i.e., tax notices) via one or more natural language processing and/or machine learning algorithms.

Document processing engine 522 may be used in conjunction with one or more methods as described above. Upload documents (e.g., tax notices) received at computing device 500 may be fed into document processing engine 522 to analyzing and classify the documents and provide information and suggestions about the document to a user in real-time.

The described features may be implemented in one or more computer programs that may be executable on a programmable system including at least one programmable processor coupled to receive data and instructions from, and to transmit data and instructions to a data storage system (e.g., database(s) 106), at least one input device, and at least one output device. A computer program is a set of instructions that can be used, directly or indirectly, in a computer to perform a certain activity or bring about a certain result. A computer program may be written in any form of programming language (e.g., Janusgraph, Gremlin, Sandbox, SQL, Objective-C, Java), including compiled or interpreted languages, and it may be deployed in any form, including as a stand-alone program or as a module, component, subroutine, or other unit suitable for use in a computing environment.

Suitable processors for the execution of a program of instructions may include, by way of example, both general and special purpose microprocessors, and the sole processor or one of multiple processors or cores, of any kind of computer. Generally, a processor may receive instructions and data from a read-only memory or a random-access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as an LED or LCD monitor for displaying information to the user and a keyboard and a pointing device such as a mouse or a trackball by which the user can provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API. An API may define one or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

It is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

Although the present invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the scope of the appended claims. For example, it is to be understood that the present invention contemplates that, to the extent possible, one or more features of any embodiment can be combined with one or more features of any other embodiment.

1. A system comprising:
a server comprising one or more processors; and
a non-transitory memory, in communication with the server, storing instructions that when executed by the one or more processors, causes the one or more processors to implement a method comprising:
receiving a document in a first format;
converting the document to a second format and extracting text from the document in the second format;
mapping the extracted text to vectors using a term frequency inverse document frequency model and one or more of:
a countvectorizer; or
a one-hot encoder;
identifying a document type associated with the document included in the extracted text;
classifying the document, using a machine learning classification model, into a predefined category based on an output of the term frequency inverse document frequency model, a second output of the countvectorizer or the one-hot encoder, and the document type associated with the document, wherein the machine learning classification model includes a tree-based ensemble model, each tree-based model within the tree-based ensemble model being trained on a different feature associated with one or more previously analyzed documents, including at least:
a first tree-based ensemble model trained on historical actions taken by a user on the one or more previously analyzed documents, the historical actions, document type, and a document sub-type being labeled for training the machine learning classification model; and
a second tree-based ensemble model trained on features related to an entity source of the document;
wherein the tree-based ensemble model outputs a score which indicates a probability of the document being associated with a pre-defined category.

2. The system of claim 1, wherein the document is a notice from a tax issuing agency; and
wherein identifying the document type associated with the document included in the extracted text, further comprises comparing the document type with a list of known document types.

3. The system of claim 1, further comprising fine-tuning the term frequency inverse document frequency model and the machine learning classification model based on word embeddings generated via a question answering model.

4. (canceled)

5. (canceled)

6. (canceled)

7. The system of claim 1, generating instructions for displaying the document type and user actions that can be taken with the document, based on the document type, via a graphical user interface with an incorporated intelligent chat tool.

8. A computer-implemented method comprising:
receiving a document in a first format;
converting the document to a second format and extracting text from the document in the second format;
mapping the extracted text to vectors using a natural language processing model and one or more of:
a countvectorizer; or
a one-hot encoder;
identifying a document type associated with the document included the extracted text;
classifying the document, using a machine learning classification model, into a predefined category based on an output of the natural language processing model and the document type associated with the document, wherein the machine learning classification model includes a tree-based ensemble model, each tree-based model within the tree-based ensemble model being trained on a different feature associated with one or more previously analyzed documents, including at least:
a first tree-based ensemble model trained on historical actions taken by a user on the one or more previously analyzed documents, the historical actions, document type, and a document sub-type being labeled for training the machine learning classification model; and
a second tree-based ensemble model trained on features related to an entity source of the document;
wherein the tree-based ensemble model outputs a score which indicates a probability of the document being associated with a pre-defined category.

9. The computer-implemented method of claim 8, wherein the document is a notice from a tax issuing agency; and
wherein identifying the document type associated with the document included in the extracted text, further comprises comparing the document type with a list of known document types.

10. The computer-implemented method of claim 8, further comprising fine-tuning the natural language processing model and the machine learning classification model based on word embeddings generated via a question answering model.

11. (canceled)

12. (canceled)

13. (canceled)

14. The computer-implemented method of claim 8, generating instructions for displaying the document type and user actions that can be taken with the document, based on the document type, via a graphical user interface with an incorporated intelligent chat tool.

15. A system comprising:
a server comprising one or more processors; and
a non-transitory memory, in communication with the server, storing instructions that when executed by the one or more processors, causes the one or more processors to implement a method comprising:
receiving a document;
removing predetermined objects from the document using a natural language processing model, wherein the natural language processing model is a term frequency inverse document frequency model;
mapping text in the document to vectors using the term frequency inverse document frequency model and one or more of:
a countvectorizer; or
a one-hot encoder;
identifying a document type associated with the document;
classifying the document, using a machine learning classification model, into a predefined category based on an output of the natural language processing model and the document type, wherein the machine learning classification model includes a tree-based ensemble model, each tree-based model within the tree-based ensemble model being trained on a different feature associated with one or more previously analyzed documents, including at least:
a first tree-based ensemble model trained on historical actions taken by a user on the one or more previously analyzed documents, the historical actions, document type, and a document sub-type being labeled for training the machine learning classification model; and
a second tree-based ensemble model trained on features related to an entity source of the document;
wherein the tree-based ensemble model outputs a score which indicates a probability of the document being associated with a pre-defined category.

16. The system of claim 15, wherein the document is a notice from a tax issuing agency; and
wherein identifying the document type associated with the document, further comprises comparing the document type with a list of known document types.

17. The system of claim 15, further comprising fine-tuning the natural language processing model and the machine learning classification model based on word embeddings associated generated via a question answering model.

18. (canceled)

19. (canceled)

20. (canceled)
